(19) United States
(12) Patent Application Publication
(10) Pub. No.: US 2012/0258429 A1
(43) Pub. Date: Oct. 11, 2012

(54) DENTAL IMPLANT SYSTEM WITH A BONE SUPERSTRUCTURE AND METHOD FOR MANUFACTURING SUCH A BONE SUPERSTRUCTURE

(76) Inventors: Rene De Clerck, Tervuren (BE); Ali Tahmaseb, Schoten (BE)

(21) Appl. No.: 13/518,482

(22) PCT Filed: Dec. 24, 2010
(86) PCT No.: PCT/BE2010/000085

§ 371 Date: Jun. 22, 2012

(30) Foreign Application Priority Data
Dec. 24, 2009 (BE) 2009/0814

(51) Int. Cl. A61C 8/00

(52) U.S. Cl. 433/174; 433/173; 433/201.1

(57) ABSTRACT

The invention concerns a method for manufacturing a bone superstructure (4) and a dental implant system with an implant (5) and a bone superstructure (4) to at least partly fill bone defects (2) in a jaw (1), whereby the bone superstructure (4) has a bone side (11) which is intended to extend opposite the bone which surrounds said bone defect (2) and a free side (10) onto which the gingiva (9) should connect, whereby this bone superstructure (4) has at least one recess (6) with a circular cross section extending between said bone side (11) and said free side (10), which recess (6) has a conical wall (8) and whereby the implant (5) is conical over at least a part (14) of its height, such that it can be mounted in the recess (6) in a substantially fitting manner.

The invention concerns a dental implant system with an implant and a bone superstructure to at least partly fill bone defects in a jaw, whereby the bone superstructure has a bone side which should extend opposite the bone which surrounds said bone defect and a free side onto which the gingiva should connect. Further, said bone superstructure has a recess with a circular cross section extending between said bone side and said free side, which recess makes it possible to fix the implant through this recess in the jaw bone.

When implants must be put in a jaw in a position where the jaw bone is resorbed and a bone defect has thus been created, a bone graft is usually provided to fill the bone defect, or it is filled with artificial bone and protected by means of a membrane.

Such systems are described for example in documents DE 199 07420, FR 2 753 366, U.S. Pat. No. 5,306,149, U.S. Pat. No. 5,759,033, U.S. Pat. No. 5,839,899, U.S. Pat. No. 6,244,868, WO 2004/112642 and WO 91/14404.

At present, the aim is to limit the number of different steps as much as possible when putting implants in a jaw and when mounting a dental prosthesis on these implants. Thus, one wishes to immediately mount a preferably definitive dental prosthesis on one or several implants as soon as they have been provided in the jaw. However, according to the present state of the art, this is not possible if there are any bone defects in the jaw in positions where an implant is to be provided.

Besides, there is also a problem in that, when providing implants in a bone defect, whereby this bone defect is filled with, for example, artificial bone, there will be a migration of epithelial cells along the part of the implant which is situated in the bone before this implant has entirely grown into this jaw bone. Such a migration of epithelial cells results in loss of the implant and possibly inflammation of the bone round the implant.

Documents WO 2009/137947, DE 10 2006 047 054 or US 2005/0113930 describe a bone superstructure through which an implant extends. Since the implant is screwed in the jaw through the bone superstructure, an opening must be provided in the bone superstructure which is large enough to allow for a rotational movement of the implant in order to screw it in the jaw. After such bone superstructures have been provided, epithelial cells and bacteria may possibly, as a consequence, migrate in the interspace between the implant and the bone superstructure, resulting in the aforesaid problem. In particular, the presence of epithelial cells in this interspace prevents bone growth and thus the growing together of the implant with the bone tissue is disturbed. Harmful bacteria which migrate into this interspace may cause inflammatory reactions and bone necrosis, which may possibly result in the loss of the implant and/or the bone superstructure.

The invention aims to remedy this with a dental implant system which makes it possible to provide implants in positions where there is a bone defect in the jaw on the one hand, for example due to bone resorption, and which makes sure that epithelial cells or bacteria cannot migrate to the interface between the bone and the implant on the other hand.

Apart from that, the implant system according to the invention also makes it possible to mount a dental prosthesis on an implant almost immediately after this implant has been provided in a bone defect.

To this aim, said recess in the bone superstructure has a conical wall and the implant is conical over at least a part of its height, such that it can be mounted in the recess in an almost fitting manner.

Practically, the bone superstructure has such a shape that its aforesaid bone side connects to the bone round said bone defect when the bone superstructure has been mounted in the bone defect.

According to a preferred embodiment of the implant system according to the invention, the diameter of the cross section of said recess gradually decreases as of the free side of the bone superstructure towards the bone side.

Advantageously, the bone superstructure has an open structure.

According to an interesting embodiment of the implant system according to the invention, said free side of the bone superstructure has at least one protrusion to support an interdental papilla.

The invention also concerns a method for manufacturing a bone superstructure to at least partly fill a bone defect in a jaw, whereby a three-dimensional image is generated of at least a part of the jaw where said bone defect is situated, and on the basis of which image a shape is determined for said bone superstructure with a bone side which is to connect to the bone round said bone defect and a free side onto which the gingiva are to connect. An implant is hereby selected with a head for fixing a dental prosthesis and a far end opposite this head which is to be fixed in the jaw bone, whereby the implant is at least partly conical between this head and said far end.

This method is characterised in that a recess is selected in the bone superstructure which extends between said bone side and said free side and which is at least partly conical, such that said implant can be put in said recess in a fitting manner with its conical part.

Other particularities and advantages of the invention will become clear from the following description of a few special embodiments of the implant system and the method according to the invention; this description is given as an example only and it does not restrict the scope of the claimed protection in any way; the figures of reference used hereafter refer to the accompanying drawings.

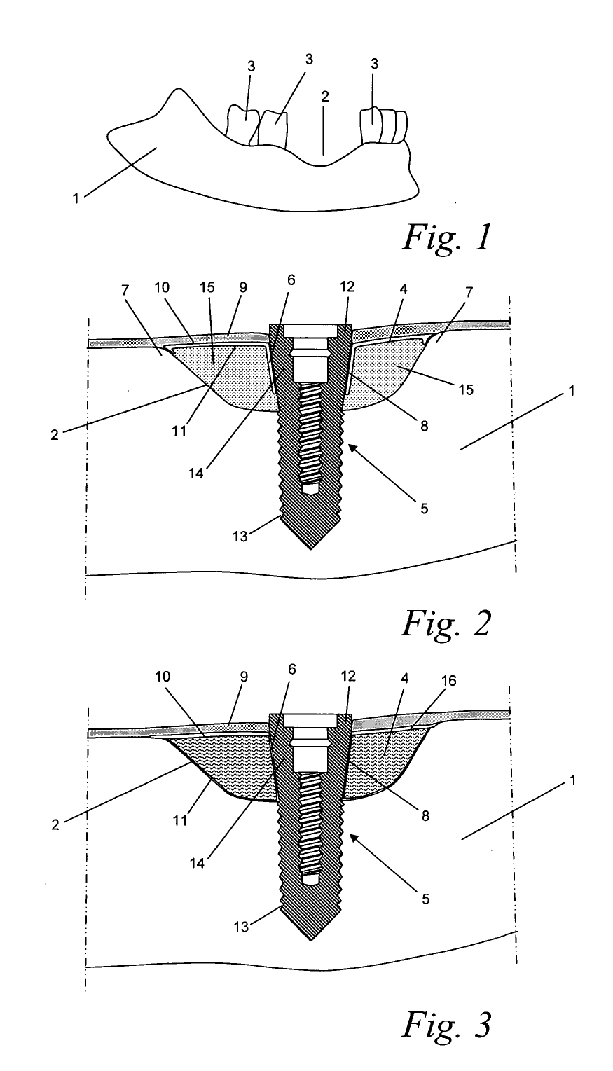

FIG. 1 is a schematic side view of a lower jaw with a bone defect due to bone resorption.

FIG. 2 is a schematic longitudinal section of a jaw with a bone defect in which is provided a bone superstructure according to a first embodiment of the invention.

FIG. 3 is a schematic longitudinal section of a jaw with a bone defect in which is provided a bone superstructure according to a second embodiment of the invention.

In the different drawings, the same figures of reference refer to identical or analogous elements.

The invention generally concerns dental implants being provided in a jaw having one or several bone defects and whereby it is thus not possible to provide one or several implants in the jaw bone. Such bone defects are situated in the parts of a jaw where the jaw bone is not sufficiently high or thick for anchoring an implant. In general, a bone defect indicates a part of the jaw that is too weak for fixing an implant in the bone thereof

FIG. 1 represents a jaw 1 having a bone defect 2. At this bone defect 2, the jaw bone has disappeared, for example due to bone resorption. Consequently, if one wishes to provide a dental prosthesis on one or several implants at said bone defect 2 between the other teeth 3 in the jaw 1, it is necessary to fill this bone defect 2 in order to provide for a sufficient base for anchoring the implants.

There are different techniques, known as such to the professional, for filling a bone defect 2 before providing implants in the position of said bone defect. However, these techniques require a long length of time to make bone grow in said bone defect, during which period it is impossible to provide implants.

The present invention mainly aims to fill a bone defect and to simultaneously provide one or several implants in this bone defect. Moreover, these implants according to the invention can normally be almost immediately loaded, such that it is possible to also fix a dental prosthesis on these implants immediately or very shortly after the implants have been provided.

In order to make this possible, the implant system according to the invention provides for a bone superstructure and at least one implant working in conjunction with the latter.

FIG. 2 represents a first embodiment of a bone superstructure 4 according to the invention as fixed in the bone defect 2 of a jaw 1 by means of an implant 5. This bone superstructure 4 is plate-shaped and has a recess 6 through which the implant 5 extends.

In particular, this bone superstructure 4 extends at the required level of the jaw bone 1 at said bone defect 2, and it connects to the edge 7 of this bone defect 2 at said required level. Thus, the bone superstructure 4 seals the bone defect 2.

Said recess 6 has a circular cross section and a wall 8 with a conical inner surface. The diameter of this recess 6 gradually decreases as of the free side 10 of the bone superstructure 4, onto which the gingiva 9 connect, towards the bone side 11.

The bone superstructure 4 may for example be made of titanium, whereby its free side 10 may possibly have an open structure and is separated from the gingiva 9 by a membrane which can possibly be resorbed and which forms a barrier to the migration of epithelial cells. It is also possible to make the bone superstructure 4 entirely out of a resorbable material which is preferably sufficiently stiff to seal the bone defect 2 in a stable manner.

The implant 5 has a head 12 for fixing a dental prosthesis and a far end 13 opposite said head which is fixed in the jaw bone 2. This far end 13 is preferably threaded, as shown in FIG. 2, and it extends past said bone side 11 into the jaw bone 1.

Further, a part 14 of the outer surface of this implant 5 is made conical. In particular, this part 14 extends between the head 12 and the far end 13 over the height of the conical wall 8 of the recess 6. The implant 5 is thereby mounted in a fitting manner in the conical recess 6 with this part 14. As the outer surface of the implant 5 thus fits closely to the wall 8 of the recess 6, no epithelial cells, bacteria or other elements which might be detrimental to the implant 5 growing together with the jaw bone 1 can migrate between the implant 5 and the wall 8.

Moreover, thanks to the conical shape of the recess 6 and the implant 5, the latter will be clamped in the recess 9 due to the downward movement of the implant 5 when the latter is subjected to a screw motion while providing it in the jaw. In particular, the bone superstructure 4 is first provided in the bone defect 2, and subsequently the implant 5 is screwed through the recess 6 in the jaw bone 1 until the bone superstructure 4 is pushed firmly against the jaw bone 1 and is thus fixed.

Before the bone superstructure 4 is provided on the bone defect 2, the volume of the bone defect 2, situated round the implant 5, is filled with bone tissue or with artificial bone 15.

Alternatively, this bone tissue or artificial bone 15 can already be fixed to the bone side 11 of the bone superstructure 4, possibly by means of a membrane with an open structure. The volume between the bone side 11 and the wall 8 of the recess is hereby filled with bone tissue or artificial bone 15.

FIG. 3 represents a second embodiment of a bone superstructure 4 according to the invention. This bone superstructure 4 is fixed in the bone defect 2 of a jaw 1 by means of an implant 5.

The bone superstructure 4 has a free side 10 over which the gingiva 9 must extend and a bone side 11 which connects to the jaw bone 1 surrounding the bone defect 2. The bone superstructure 4 thus fills the bone defect 2 almost entirely.

This bone superstructure 4 is preferably made by means of what is called a “rapid prototyping” technique such as for example selective laser sintering or selective laser melting of a metal or plastic powder on the basis of a digital three-dimensional model of the bone defect 2.

To this end, a three-dimensional image is generated of at least the part of the jaw 1 where the aforesaid bone defect 2 is situated. This can be done for example by making a CT scan of the jaw 1. On the basis of this image, a shape is determined for the bone superstructure 4 as well as an optimal position to provide the implant 5 in the jaw 1.

When determining the shape of the bone superstructure 4, a recess 6 is thus provided in this element 4 through which the implant 5 must extend, taking into account the optimal position of the implant 5. The recess 6 has a circular cross section and extends between said bone side 11 and said free side 10, whereby this recess 6 has a conical wall 8. The diameter of the cross section of said recess 6 gradually decreases as of the free side 10 of the bone superstructure 4 to the bone side 11.

The implant 5 has a head 12 for fixing a dental prosthesis and a far end 13 opposite this head 12 which is to be fixed in the jaw bone 1. This far end 13 is provided with outside thread to be screwed in the jaw bone 1. Between the head 12 and the far end 13, the implant 5 is conical over part of its length, as is the case in the first embodiment of the invention, such that it can be fit in the recess 6 with its conical part 14.

Preferably, at least a part of the bone superstructure 4 has an open structure or it is porous such that bone growth is possible therein.

In the bone superstructure 4 can thus be provided cavities which open in the bone side 11 and which are filled with bone tissue or with artificial bone before the bone superstructure is provided in the corresponding bone defect 2.

In addition to this, also on the basis of said three-dimensional image of the jaw 1 and the selected optimal position for the implant 5, a template is preferably made for boring a cavity in the jaw 1 in the required position for the implant 5.

After this cavity has thus been provided in the jaw, the bone superstructure 4 is provided on the bone defect 2 and the implant 5 is screwed through said recess 6 in the cavity in the jaw 1. In this manner, the bone superstructure 4 is fixed to the jaw on the one hand, and the bone superstructure 4 forms a support providing stability to the implant 5 on the other hand.

As said recess 6 is conical and has a smooth surface, while screwing the implant 5 in the jaw, its conical part 14 will be gradually pushed to the smooth surface of the recess 6 of the bone superstructure 4 until a narrow fit is obtained between the surface of the recess 6 and the conical part 14 of the implant 5. This almost perfect fit is obtained as the implant 5, while being axially moved, is guided with the conical part 14 through the conical recess 6, such that the implant 5 centres in relation to the recess 6 and both of them consequently extend coaxially. Thus, the implant 5 can be screwed in the jaw until the surface of its conical part 14 fits tightly to the conical surface of the recess 6 and both surfaces are pushed against one another.

Thus, the surface of the conical wall 8 of the recess 6 of the bone superstructure 4 is complementary to the surface of the conical part 14 of the implant 5 and both surfaces are preferably almost entirely smooth, such that a contact surface is obtained between the wall 8 of the recess 6 and the conical part 14 of the implant that is as large as possible.

A membrane 16 may possibly be provided on said free side 10 of the bone superstructure 4 which forms a barrier to the migration of epithelial cells.

Naturally, the method for manufacturing the bone superstructure 4 according to the above-mentioned second embodiment can also be applied for manufacturing a bone superstructure according to the first embodiment of the invention.

Besides, the use of a bone superstructure 4 is advantageous in that, on its free side 10, one or several protrusions can be provided forming a support for the gingiva which connect to a dental prosthesis which is mounted on an implant, such that these protrusions support the interdental papillae. Such protrusions can be formed as a whole with the bone superstructure while the latter is being manufactured, or they can possibly be fixed to the bone superstructure, for example, by means of screws.

The bone superstructure may be formed of titanium or any other biocompatible metal or material or it may also be formed of a resorbable material known as such.

Naturally, the invention is not restricted to the above-described embodiments of the dental implant system and the method for manufacturing a bone superstructure as represented in the figures.

Thus, it is obviously possible for one and the same bone superstructure to have several recesses, such that it can be fixed to a jaw with several implants.

It is also possible to apply the dental implant system and the method for building a jaw bone where the jaw is too thin or too low to solidly provide an implant in.

1. Dental implant system with an implant (5) and a bone superstructure (4) to at least partly fill bone defects (2) in a jaw (1), whereby the bone superstructure (4) has a bone side (11) which is intended to extend opposite the bone which surrounds said bone defect (2) and a free side (10) onto which the gingiva (9) should connect, whereby this bone superstructure (4) has at least one recess (6) with a circular cross section extending between said bone side (11) and said free side (10), which recess (6) makes it possible to fix the implant (5) through this recess (6) in the jaw bone (1), characterised in that said recess (6) has a conical wall (8) and the implant (5) is conical over at least a part (14) of its height, such that it can be mounted in the recess (6) in a substantially fitting manner.

2. Implant system according to claim 1, whereby said recess (6) has a conical wall (8) with a smooth surface and the implant (5) is conical over at least a part (14) of its height and has a smooth surface at this part.

3. Implant system according to claim 1 or 2, whereby the diameter of the cross section of said recess (6) gradually decreases as of the free side (10) of the bone superstructure (4) towards the bone side (11).

4. Implant system according to claim 1 or 2, whereby said implant (5) has a head (12) for fixing a dental prosthesis and a far end (13) opposite said head (12) which is to be fixed in the jaw bone (1), whereby this opposite far end (13) extends past said bone side (11) when the implant (5) is provided in the recess (6) of the bone superstructure (4) in a fitting manner.

5. Implant system according to claim 1 or 2, whereby said conical part (14) of the implant (5), on its broad side, connects to said head (12) and, on the narrow side of this part (14), connects to the above-mentioned opposite far end (13) of the implant, which far end (13) is threaded.

6. Implant system according to claim 1 or 2, whereby the bone superstructure (4) is at least partly formed of a porous material.

7. Implant system according to claim 1 or 2, whereby the bone superstructure (4) has an open structure.

8. Implant system according to claim 1 or 2, whereby said free side (10) of the bone superstructure (4) has at least one protrusion to support an interdental papilla.

9. Implant system according to claim 1 or 2, whereby the bone superstructure (4) is at least partly filled with bone tissue or with artificial bone (15).

10. Implant system according to claim 1 or 2, whereby the bone superstructure (4) is at least partly formed of a resorbable material.

11. Implant system according to claim 1 or 2, whereby a membrane (6) is provided on said free side (10) of the bone superstructure (4) forming a barrier to the migration of epithelial cells.

12. Implant system according to claim 1 or 2, whereby the bone superstructure (4) has such a shape that its aforesaid bone side (11) connects to the bone round said bone defect (2) when the bone superstructure (4) is mounted in the bone defect (2).

13. Method for manufacturing a bone superstructure (4) to at least partly fill a bone defect (2) in a jaw (1), whereby a three-dimensional image of at least a part of the jaw (1) is generated where said bone defect (2) is situated, and a shape for said bone superstructure (4) is determined on the basis of said image having a bone side (11) which is to connect to the bone round said bone defect (2) and a free side (10) onto which the gingiva (9) are to connect, whereby an implant (5) is selected with a head (12) for fixing a dental prosthesis and a far end (13) opposite to this head (12) which is to be fixed in the jaw bone (1), whereby the implant (5) between this head (12) and said far end (13) is at least partly conical, characterised in that at least one recess (6) is provided in the bone superstructure (4) extending between said bone side (11) and said free side (10), whereby this recess (6) is at least partly conical, such that said implant (5) can be fit in said recess (6) with its conical part.

14. Method according to claim 13, whereby said implant (5) is selected such that said far end opposite to the head (12) of the implant (5) extends past said bone side (11).

15. Method according to claim 13 or 14, whereby said bone superstructure (4) provided with said recess (6) is made by means of a “rapid prototyping” technique.

16. Method according to claim 13 or 14, whereby said bone superstructure (4) is made such that its structure is at least partly open.

17. Method according to claim 13 or 14, whereby said bone superstructure (4) is provided with at least one cavity opening in said bone side (11), whereby this cavity is filled with bone tissue or artificial bone (15).

18. Method according to claim 13 or 14, whereby a membrane (6) is provided on said free side (10) of the bone superstructure (4) forming a barrier to epithelial cells.
